(19) United States
(12) Patent Application Publication
(10) Pub. No.: US 2013/0300395 A1
(43) Pub. Date: Nov. 14, 2013

(54) ACCESSORY DETECTION OVER TEMPERATURE

(71) Applicant: Gregory A. Maher, Cape Elizabeth, ME (US)

(72) Inventor: Gregory A. Maher, Cape Elizabeth, ME (US)

(21) Appl. No.: 13/469,693

(22) Filed: May 11, 2012

(51) Int. Cl. G05F 3/02

(52) U.S. Cl. 323/313

(57) ABSTRACT

This document discusses, among other things, apparatus and methods configured to accurately identify accessories coupled to mobile electronic devices over a wide range of temperature, In an example, an apparatus can include a reference voltage generator configured to provide a reference voltage, a comparator configured to compare the reference voltage to a voltage across an accessory-resistor, a current supply configured to be coupled to the accessory resistor and to provide the voltage to the comparator using the accessory resistor. The current supply can include a first sense resistor having a first temperature dependency and a second sense resistor having a second temperature dependency. In an example, the second temperature dependency can be configured to compensate for at least a portion of the first temperature dependency. In an example, at least one of the first or second temperature dependencies can be configured to control a temperature dependency of the apparatus.

### BACKGROUND

As mobile electronic devices have become more common, the functionality of the devices has expanded. In turn, designers have implemented features that provide a better user experience. Automatic identification of various attached accessories is one of many such features. However, as the size of mobile electronic devices decrease, and the ease of their mobility increase, the devices can be subjected to a wide range of temperatures, which can alter the identification of the attached accessories.

### OVERVIEW

This document discusses, among other things, apparatus and methods configured to accurately identify accessories coupled to mobile electronic devices over a wide range of temperature. In an example, an apparatus can include a reference voltage generator configured to provide a reference voltage, a comparator configured to compare the reference voltage to a voltage developed across an accessory resistor, a current supply configured to be coupled to the accessory-resistor and to provide the voltage to the comparator using the accessory resistor. The current supply can include a first sense resistor having a first temperature dependency and a second sense resistor having a second temperature dependency. In an example, the second temperature dependency can be configured to compensate for at least a portion of the first temperature dependency and can be configured to control a temperature dependency of the apparatus.

This section is intended to provide an overview of subject matter of the present patent application. It is not intended to provide an exclusive or exhaustive explanation of the invention, The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example bias circuit of a mobile device configured to bias an impedance of an attached accessory.

### DETAILED DESCRIPTION

Existing mobile devices can accommodate connection to a wide variety of accessories to expand functionality of the mobile device or to enhance the user experience with the mobile device. Many accessories include an impedance, such as an resistance via resistor for usee in identifying the accessory or identifying functions associated with the accessory. Upon connection to a mobile device, the mobile device can bias the accessory resistor with a reference current and can compare the voltage across the accessory resistor to a reference voltage. In certain examples, the reference voltage can be varied to identify one of a plurality of resistance values.

In some examples, a bias circuit can include a comparator configured to compare the reference voltage to the voltage across the accessory resistor. In an example, the bias circuit can be configured to provide an output indicative of the comparison. The output of the bias circuit can be configured to identify the resistance value of the accessory resistor. The resistance value of the accessory resistor can be used to identify the type of connected accessory. Once identified, a controller of the mobile device can configure the mobile device to optimize use of the accessory, including expanding functionality that may be offered by the accessory.

In certain examples, a bias circuit of a mobile device can be coupled to one or more terminals of a port of the mobile device to assist in identifying a connected accessory via an identification of a resistance value of the accessory. In an example, the port can be a universal serial bus (USB) port of the mobile device.

Several circumstances can affect the accuracy with which the resistance value of the resistance can be measured. One circumstance can include mismatched component layouts, for example, in the circuitry used to provide the reference current to the accessory resistor, However, even when solving issues related to layout matching, temperature dependencies of the components of the bias circuit can also contribute to false identification of a connected accessory by a mobile device.

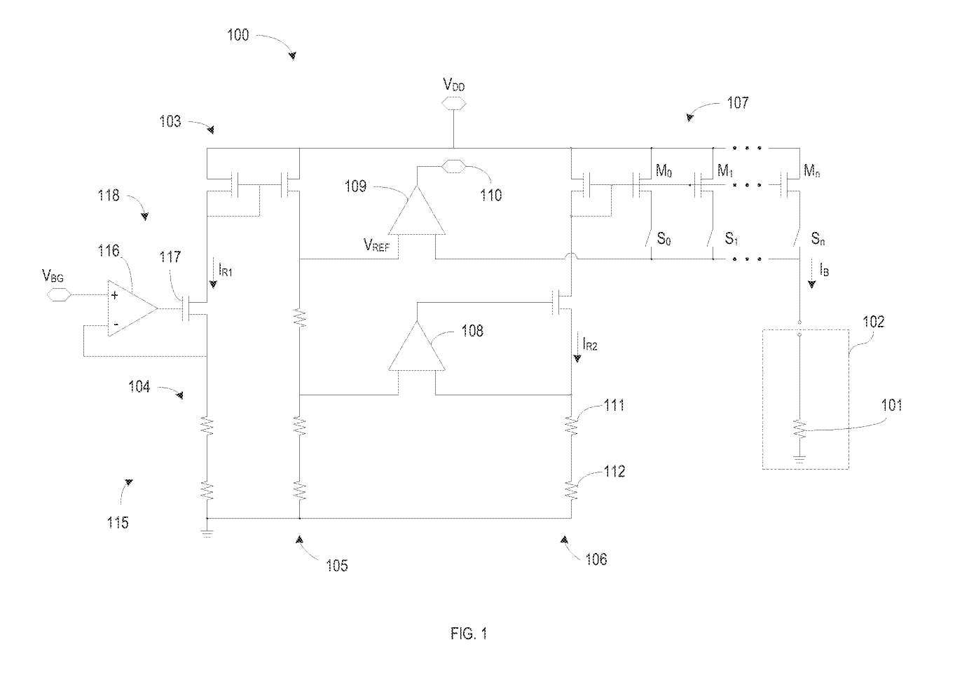

The present inventor has recognized, among other things, apparatus and methods configured to accurately identify a value of a resistance of an accessory device over a wide temperature range. FIG. 1 illustrates generally an example bias circuit 100 of a mobile device configured to bias an impedance of an attached accessory.

Resistor detection is a method of identifying accessories or batteries that have been attached to a micro-USB, an audio jack, a battery interface, or one or more other interfaces of a mobile device. Mobile devices can be subjected to large temperature ranges, including, but not limited to, environmental temperature ranges, temperature ranges associated with charging circuits, etc. In an example, if a reference current of a detection circuit, such as a current used to create a voltage on an accessory resistor 101 of a connected accessory 102, does not track with the voltage reference (V_{REF}) used to identify the accessory resistor 101, the accessory 102 can be misidentified.

In certain examples, the bias circuit 100 can allow a second reference current (I_{R2}) to substantially track the voltage reference (V_{REF}) used to identify the accessory resistor 101 over a wide range of temperatures. The bias circuit 100 can receive a first voltage reference, such as a bandgap reference (V_{BG}), at a reference voltage generator 115. The reference voltage generator 115 can include a sense current generator 118 including a first amplifier 116 and a sense current transistor 117. In an example, the sense current generator 118 and a current mirror 103 can be configured to generate a first reference current (I_{R1}) that can be a function of a first temperature coefficient (TC₁), such as the temperature coefficient of a first leg of poly resistors 104. A second leg of poly resistors 105, having the first temperature coefficient (TC₁), can be used to trim the reference voltage (V_{REF}).

In an example, the reference voltage (V_{REF}) can exhibit a temperature characteristic substantially the same as the bandgap reference (V_{BG}) as the first temperature coefficient (TC₁) of the first leg of poly resistors 104 can be cancelled out because the reference voltage (V_{REF}) is created on top of resistors of the second leg of poly resistors 105 also having the first temperature coefficient (TC₁).

A third leg 106 of the bias circuit 100 can use the reference voltage (V_{REF}), or a representation of the reference voltage, to generate the second reference current (IR₂). The second reference current (IR₂) can be used to generate a bias current (I_{B}) to bias an accessory resistor 101 of a connected accessory device 102. In certain examples, the second reference current (IR₂) can be used as a sense current for a current supply, such as an amplifying current mirror 107. The bias circuit 100 can include an amplifier 108 configured to control the second reference current (IR₂) based on a representation of the reference voltage (V_{REF}). Feedback of the second reference current (IR₂) can be generated across resistors of the third leg of poly resistors 106 of the bias circuit 100.

In certain examples, the resistors of the third leg of poly resistors 106 of the bias circuit 100 can be selected to reduce the temperature dependency, or to provide substantially zero temperature dependency, of the bias circuit 100 across a wide range of temperatures. In an example, a first sense resistor 111 of the third leg of poly resistors 106 can have the first temperature coefficient (TC₁) and a second sense resistor 112 of the third leg of poly resistors 106 can have a second temperature coefficient (TC₂) that complements, or compensates, the first temperature coefficient (TC₁) over a desired range of temperatures, such as those temperatures most likely to be encountered during use of the bias circuit 100. As a result, the bias current (I_{B}) can be provided to an accessory resistor 101 of an attached accessory device 102, and in turn, the voltage across the accessory resistor 101 can remain substantially the same over an extended range of temperatures.

In an example, the first sense resistor 111 of the third leg of poly resistors 106 can be a semiconductor resistor of a first doping type and the second sense resistor 112 of the third leg of poly resistors 106 can be a semiconductor resistor of a second doping type, such that the temperature coefficient of the second sense resistor 112 can compensate the temperature coefficient of the first sense resistor 111, or vice versa. In such an example, the complementary temperature coefficients of the first and second sense resistors 111, 112 of the third leg of poly resistors 106 can improve the temperature stability of the bias circuit 100 over a wide range of temperatures. In an example, the first sense resistor 111 can be an n-type semiconductor resistor and the second sense resistor 112 can be a p-type semiconductor resistor. In an example, the first sense resistor 111 can be a p-type semiconductor resistor and the second sense resistor 112 can be an n-type semiconductor resistor. In certain examples, an identification circuit of a mobile device can more accurately identify connected accessories at extreme temperatures when the bias current is stable over a wide range of temperatures.

In certain examples, the bias circuit 100 can include a comparator 109 configured to provide an output 110 indicative of the value of the resistance of the accessory resistor 101 of the connected accessory 102 or a value indicative of whether the voltage across the accessory resistor 101 is greater than or less than the reference voltage (V_{REF}).

In certain examples, the amplifying current mirror 107 can include a digital-to-analog current supply and can include one or more mirror transistors M₁, M₁, . . . , Mₙ and one or more associated switches S₀, S₁, . . . Sₙ, such as switch transistors. The digital-to-analog current supply can receive a number of digital inputs at the switches to select a particular bias current (I_{B}) to apply to the accessory resistor 101 based on the state of the digital inputs. In certain examples, the switches S₀, S₁, . . . , Sₙ can be controlled to set a desired bias current (I_{B}) level. In certain examples, a controller (not shown) can adjust the switches S₀, S₁, . . . , Sₙ using a series of comparisons of the reference voltage (V_{REF}) with the voltage across the accessory resistor 101. Each comparison can be used to adjust the bias current (I_{B}) applied to the accessory resistor 101 until the value of the accessory resistor 101, or resistance, can be determined within an acceptable range to identify the attached accessory 102.

In certain examples, an integrated circuit can include the comparator 109, the reference voltage generator, and the current supply.

### ADDITIONAL NOTES

In Example 1, an apparatus can include a comparator configured to compare a reference voltage to a first voltage developed across an accessory resistor and to provide an output indicative of the comparison, a reference voltage generator configured to provide the reference voltage, and a current supply configured to be coupled to the accessory resistor and to provide the first voltage to the comparator using the accessory resistor. The current supply can include a first sense resistor having a first temperature dependency, and a second sense resistor having a second temperature dependency. The second temperature dependency can be configured to compensate for at least a portion of the first temperature dependency.

In Example 2, the first resistor of Example 1 optionally is a semiconductor resistor.

In Example 3, the second resistor of any one or mornre of Examples 1-2 optionally is a semiconductor resistor.

In Example 4, the first resistor of any one or more of Examples 1-3 optionally includes a first doping type semiconductor resistor,

in Example 5, the second resistor of any one or more of Examples 1-4 optionally includes a second doping type a semiconductor resistor.

In Example 6, the first doping type of any one or more of Examples 1-5 optionally is a p-type semiconductor resistor and the second doping type of any one or more of Examples 1-5 optionally is an n-type semiconductor resistor.

In example 7, the first doping type of any one or more of Examples 1-6 optionally is a n-type semiconductor resistor and the second doping type of any one or more of Examples 1-6 optionally is an p-type semiconductor resistor.

In Example 8, the reference voltage generator of any one or more of Examples 1-7 optionally includes a bandgap voltage reference and a current mirror. The bandgap voltage reference optionally is configured to provide a reference current for the current mirror, and the current mirror optionally is configured to provide the voltage reference.

In Example 9, an integrated circuit optionally includes the comparator, the reference voltage generator, and the current supply of any one or more of Examples 1-8

In Example 10, the apparatus of any one or more of Examples 1-9 optionally includes one or more digital inputs. The current supply of any ione or more of Examples 1-9 optionally includes a digital-to-analog current supply configured to provide a selected supply current to the accessory resistor in response to a state of the one or more digital inputs.

In Example 11, the apparatus of any one or more of Examples 1-10 optionally includes a terminal coupled to the current supply. A universal serial bus (USB) port can include the terminal.

In Example 12, a method can include generating a reference voltage using a reference voltage generator, providing current to an accessory resistor coupled to a current supply, providing an identification voltage to a comparator using the current and the identification resistor, comparing the reference voltage with the identification voltage at the comparator, providing an indication of the comparison at an output, and compensating for at least a portion of a first temperature dependency of a first resistor of the current supply using a second temperature dependency of a second resistor of the current supply.

In Example 13, the generating a reference voltage of any one or more of Examples 1-12 optionally includes generating a reference voltage using a bandgap voltage reference.

In Example 14, the generating a reference voltage of any one or more of Examples 1-13 optionally includes providing a reference current to a sense transistor of a current mirror of the reference voltage generator using the bandgap voltage reference, and the method optionally includes providing a mirror current of the reference current using a mirror transistor of the current mirror.

In Example 15, the generating the reference voltage of any one or more of Examples 1-14 optionally includes generating the reference voltage using the mirror current.

In Example 16, the providing a current of any one or more of Examples 1-15 optionally includes includes receiving one or more digital inputs at the current supply.

In Example 17, the providing a current of any one or more of Examples 1-16 optionally includes controlling one or more transistors in response to the received one or more digital inputs to select a level of the current.

In Example 18, a system can include a controller, a universal serial bus (USB) port, and a bias circuit coupled to the controller and the USB port. The bias circuit can include a comparator configured to compare a reference voltage to an identification voltage and to provide an output indicative of the comparison, a reference voltage generator configured to provide the reference voltage, and a current supply configured to be coupled to an accessory resistor and to provide the identification voltage to the comparator using the identification resistor. The current supply can include a current limit resistor. The current limit resistor can include a first resistor having a first temperature dependency, and a second resistor having a second temperature dependency. The second temperature dependency can be configured to compensate for at least a portion of the first temperature dependency.

In Example 19, the bias circuit of any one or more of Examples 1-18 optionally includes one or more digital inputs coupled to the controller. The current supply can include a digital-to-analog current supply configured to provide a selected supply current to the accessory resistor in response to a state of the one or more digital inputs.

In Example 20, an integrated circuit optionally includes the bias circuit of any one or more of Examples 1-19.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. In other examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus comprising:
a comparator configured to compare a reference voltage to a first voltage developed across an accessory resistor and to provide an output indicative of the comparison;
a reference voltage generator configured to provide the reference voltage; and
a current supply configured to be coupled to the accessory resistor and to provide the first voltage to the comparator using the accessory resistor;
wherein the current supply includes:
a first sense resistor having a first temperature dependency; and
a second sense resistor having a second temperature dependency; and
wherein the second temperature dependency is configured to compensate for at least a portion of the first, temperature dependency.

2. The apparatus of claim 1, wherein the first resistor is a semiconductor resistor.

3. The apparatus of claim 1, wherein the second resistor is a semiconductor resistor.

4. The apparatus of claim 1, wherein the first resistor includes a first doping type semiconductor resistor.

5. The apparatus of claim 4, wherein the second resistor includes a second doping type a semiconductor resistor.

6. The apparatus of claim 5, wherein the first doping type is a p-type semiconductor resistor and the second doping type is an n-type semiconductor resistor.

7. The apparatus of claim 5, wherein the first doping type is a n-type semiconductor resistor and the second doping type is an p-type semiconductor resistor.

8. The apparatus of claim 1, wherein the reference voltage generator includes a bandgap voltage reference and a current mirror;
wherein the bandgap voltage reference is configured to provide a reference current for the current mirror; and
wherein the current mirror is configured to provide the voltage reference.

9. The apparatus of claim 1, wherein an integrated circuit includes the comparator, the reference voltage generator, and the current supply.

10. The apparatus of claim 1, including one or more digital inputs; and
wherein the current supply includes a digital-to-analog current supply configured to provide a selected supply current to the accessory resistor in response to a state of the one or more digital inputs.

11. The apparatus of claim 1, including a terminal coupled to the current supply, wherein a universal serial bus (USB) port includes the terminal.

12. A method comprising:
generating a reference voltage using a reference voltage generator;
providing current to an accessory resistor coupled to a current supply;
providing an identification voltage to a comparator using the current and the identification resistor;
comparing the reference voltage with the identification voltage at the comparator;
providing an indication of the comparison at an output; and
compensating for at least a portion of a first temperature dependency of a first resistor of the current supply using a second temperature dependency of a second resistor of the current, supply.

13. The method of claim 12, wherein generating a reference voltage includes generating a reference voltage using a bandgap voltage reference.

14. The method of claim 13, wherein generating a reference voltage includes providing a reference current to a sense transistor of a current mirror of the reference voltage generator using the bandgap voltage reference: and
providing a mirror current, of the reference current using a mirror transistor of the current mirror.

15. The method of claim 14, wherein generating the reference voltage includes generating the reference voltage using the mirror current.

16. The method of claim 12, wherein providing a current includes receiving one or more digital inputs at the current supply.

17. The method of claim 16, wherein providing a current includes controlling one or more transistors in response to the received one or more digital inputs to select a level of the current.

18. A system comprising;
a controller;
a universal serial bus (USB) port; and
a bias circuit coupled to the controller and the USB port, the bias circuit including:
a comparator configured to compare a reference voltage to an identification voltage and to provide an output indicative of the comparison;
a reference voltage generator configured to provide the reference voltage; and
a current supply configured to be coupled to an accessory resistor and to provide the identification voltage to the comparator using the identification resistor;
wherein the current supply includes a current limit resistor, the current limit, resistor including:
a first resistor having a first temperature dependency; and
a second resistor having a second temperature dependency: and
wherein the second temperature dependency is configured to compensate for at least a portion of the first temperature dependency.

19. The system of claim 18, wherein the bias circuit includes one or more digital inputs coupled to the controller; and
wherein the current supply includes a digital-to-analog current supply configured to provide a selected supply current to the accessory resistor in response to a state of the one or more digital inputs.

20. The system of claim 18, wherein an integrated circuit includes the bias circuit.
